(19) United States
(12) Patent Application Publication
(10) Pub. No.: US 2015/0015214 A1
(43) Pub. Date: Jan. 15, 2015

(54) ACTIVE VIBRATION DAMPING USING ALTERNATOR

(71) Applicant: REMY TECHNOLOGIES, L.L.C., Pendleton, IN (US)

(72) Inventor: William E. Bowman, Fishers, IN (US)

(21) Appl. No.: 14/326,064

(22) Filed: Jul. 8, 2014

Related U.S. Application Data
(60) Provisional application No. 61/844,216, filed on Jul. 9, 2013.

(51) Int. Cl. H02P 9/14; H02P 9/02

(52) U.S. Cl. CPC H02P 9/14; H02P 9/02; H02P 2009/002
USPC 322/22

(57) ABSTRACT

A method of performing active vibration damping in a front end accessory drive (FEAD) system of an automobile using an alternator of the FEAD system and an alternator are described. The method includes determining a resonance to be counteracted, determining a counteracting forcing function to counteract the resonance, and determining a duty cycle change to apply to a field voltage to obtain an output voltage with the counteracting forcing function, wherein the field voltage results in a field current supplied to a rotor that causes a stator to generate the output voltage. The method also includes implementing the duty cycle change for a period of time.

### CROSS REFERENCE TO RELATED APPLICATIONS

This application is a non-provisional of U.S. Provisional Patent Application No. 61/844,216 filed on Jul. 9, 2013, the disclosure of which is incorporated herein by reference in its entirety.

### BACKGROUND OF THE INVENTION

Exemplary front end accessories of vehicles include components such as an alternator, water pump, fan, and air conditioning compressor. These components are driven by a front end accessory drive (FEAD) or belt drive system. The FEAD is, thus, coupled to multiple dynamic loads that each exerts generally different forces and torques during their operation. The greater the number of front end accessories, the more complex the dynamics of the system. The dynamics are functions of parameters such as pulley diameter, inertia, load caused by transfer of energy, and engine speed.

One exemplary condition where vibration is likely to be experienced is when a vehicle is idling with the air conditioner on. Under this condition, the load on the FEAD is not consistent but, rather, it varies depending upon whether or not the air conditioning compressor clutch is engaged or disengaged, each of which conditions occur sporadically as temperature sensors and settings inside a passenger compartment of the vehicle call for cooling or signal that the temperature has reached a preset point. Similarly, a water pump may load the belt in a constant manner or may also experience sporadic load changes if a fan is attached thereto and is clutched. In either case, some vibration is likely to be experienced due to the nature of an impeller, which most vehicular water pumps are. The power steering pump applies a parasitic load to the belt at all times, but when a steering wheel of the vehicle is turned, the power steering pump draws more energy from the belt creating a vibration in the system. The alternator is an additional load with its high mass moment of inertia. When large electrical loads are applied and removed, the alternator impacts FEAD vibrations. As noted above, engine speed itself, as well as engine size horsepower and torque capability have an effect on vibration. When the engine is at low speed or otherwise exhibits a low torque, any load placed thereon will draw engine RPM down more significantly than at higher speed or higher torque output conditions. The rebound effect from such draw down will be experienced as a vibration.

The dynamically different functions of the front end accessories, applying variable torque to the closed loop system, variably interact over time to sometimes amplify each other, sometimes detract from each other, and everything in between. Standing waves may also be produced in the belt, causing displacement of the idle/tensioner components of the FEAD. The resulting vibration is generally noticeable to an occupant of the vehicle. Additionally, if and when the phases of various acoustic waves directly overlap, amplitude peaks may be sufficiently high to significantly reduce service life of such components as belts, pulleys, and bearings, increasing repair frequency and thereby cost. Reduction of such vibrations can result in a smoother drive of the vehicle and longer service life for the FEAD components.

Because of its inertia and high variable torque, the alternator is a leading contributor to the instability and resonances experienced by the FEAD. “Softening” or “decoupling” the response of the alternator can therefore have a commensurately greater effect on the reduction of vibrations, oscillations, resonances, and wear on the FEAD components. Not surprisingly, attempts have been made to address alternator induced vibrations. Two currently used mechanical apparatuses to control FEAD resonances are the overrunning alternator pulley (OAP) and the overrunning alternator damper (OAD). The OAP and OAD buffer the torque producing alternator from the belt and drive to reduce vibration initiation.

While OAP and OAD systems are functional, they add weight and cost to the total vehicular system and, accordingly, alternative means of addressing FEAD instability would be welcomed by the art.

### BRIEF DESCRIPTION OF THE INVENTION

According to an embodiment, a method of performing active vibration damping in a front end accessory drive (FEAD) system of an automobile using an alternator of the FEAD system includes determining a resonance to be counteracted; determining a counteracting forcing function to counteract the resonance; determining a duty cycle change to apply to a field voltage to obtain an output voltage with the counteracting forcing function, wherein the field voltage results in a field current supplied to a rotor that causes a stator to generate the output voltage; and implementing the duty cycle change for a period of time.

According to another embodiment, an alternator of a front end accessory drive (FEAD) system of an automobile configured to perform active vibration damping includes a voltage regulator configured to control a field current at a rotor, the voltage regulator controlling the field current by controlling a duty cycle of a pulse width modulated field voltage; the rotor configured to generate a magnetic field based on the field current; a stator surrounding the rotor, the stator generating an output voltage of the alternator based on the magnetic field; and a processor configured to determine a change in the duty cycle of the field voltage for a period of time to generate the output voltage with a counteracting forcing function to perform the active vibration damping.

### BRIEF DESCRIPTION OF THE DRAWINGS

The following descriptions should not be considered limiting in any way. With reference to the accompanying drawings, like elements are numbered alike:

FIG. 1 is a cross-sectional view of aspects of a front end accessory drive system;

FIG. 2 is a simplified block diagram of an alternator according to embodiments of the invention.

FIG. 3 is a process flow of a method of performing active vibration damping of the FEAD system according to an embodiment of the invention; and

FIG. 4 is a process flow of a method of performing active vibration damping of the FEAD system according to another embodiment of the invention.

### DETAILED DESCRIPTION OF THE INVENTION

A detailed description of one or more embodiments of the disclosed apparatus and method are presented herein by way of exemplification and not limitation with reference to the Figures.

As noted above, components of the FEAD system (the dynamic loads such as steering, air conditioning, pumps, and alternator) that exert significant forces and torques during their operation can cause vibrations that affect ride comfort and may generate standing waves that create displacement of the idle/tensioner components. All of these machines have rotating elements which apply unique and dynamic loads to the belt. The complex dynamics are functions of, for example, pulley diameter, inertia, and load cause by transfer energy, and engine speed.

An illustrative scenario is when a vehicle is idling, with the air conditioner on. The water pump draws some constant energy from the belt. The power steering pump also applies a parasitic load to the belt and, when the wheel is turned, the power steering pump draws even more energy from the belt. The alternator also applies a load. When large electrical loads are applied and removed, the alternator jerks around the FEAD. At low speed, the engine output energy is low relative to higher speeds. When all the loads are applied, their unique responses pull energy from the drive train and reduce the engine speed. In the process of finding stability, the system undergoes resonances, vibrations, and rough handling.

When the dynamically different functions of the FEAD components, applying variable torque to the closed loop system, are aggregated, standing waves can be produced in the long rubber belt causing extreme displacement of the idle/tensioner. The resulting vibration may be noticeable and objectionable. Additionally, if these resonances combine and reinforce each other, the resulting gyrations stress the belts, pulleys, and bearings. The further the vibrations can be reduced, the smoother the drive and longer the component life.

As also noted above, the alternator is a FEAD component that may largely contribute to instability and resonances. Alternators include a field winding and a stator winding. When field current is applied to the field winding, it generates a magnetic field that produces a current in the stator winding. The regulator controls the field current to ensure that the output voltage of the alternator remains within a desired range.

When an electrical load is applied to the alternator, the regulator increases the field current, thereby increasing the alternator torque. When the electrical load is decreased, the field current is decreased by the regulator, and the alternator torque drops. This dynamic torque, in conjunction with other components that share the FEAD, may cause oscillations, vibrations, and instabilities. However, the same force that leads to the instability may be used to dampen the instability when appropriately controlled, as described below.

First, two current efforts to control FEAD resonances are briefly discussed. The OAP is a one way clutch that adds a non-linear element to the system control loop, thereby breaking the instability in the circuit. This “one way effect” breaks up the oscillation like a diode in an electronic control circuit. It is open in one direction and closed in the other direction. The OAP applies torque in one direction, but releases in the reverse direction, breaking up the oscillation. The OAD is a mechanical damper that changes the frequency response of the alternator. Increasing the circuit damping (like, increasing the capacitance value in an electrical circuit) attenuates the oscillation below the level where they can sustain. Both pulleys (OAD/OAP) “break” the direct link between the pulley speed and the alternator speed. At the highest level, the OAD and OAP are mechanical devices used to reduce the engine vibration, instability and resonances. The embodiments discussed below focus, instead, on an electrical approach to active vibration damping.

Specifically, the regulator of an alternator may increase or decrease field current to affect alternator torque and thereby control stability according to one or more embodiments. According to one embodiment, the regulator monitors the variables within the alternator (e.g., speed, voltage, current), calculates a torque that brings the alternator to stability, and modulates the field voltage to develop the forcing function to apply the calculated torque. According to this embodiment, the regulator (alone or in conjunction with another controller) controls alternator output voltage as before and additionally reduces FEAD instability by addressing the component of instability introduced by the alternator, which is a significant contributor to overall FEAD dynamics.

According to another embodiment, a controller (e.g., the regulator alone or in conjunction with one or more processors) monitors variables within the overall FEAD system. That is, one or more sensor outputs may indicate to the controller the dynamics (instability) being introduced by accessories such as the air conditioning compressor and water pump, for example. The controller calculates an alternator torque that counteracts these dynamics and modulates the field voltage accordingly. Thus, according to this embodiment, the controller (e.g., regulator) not only controls the alternator component of FEAD instability but also the overall FEAD instability by controlling the alternator torque.

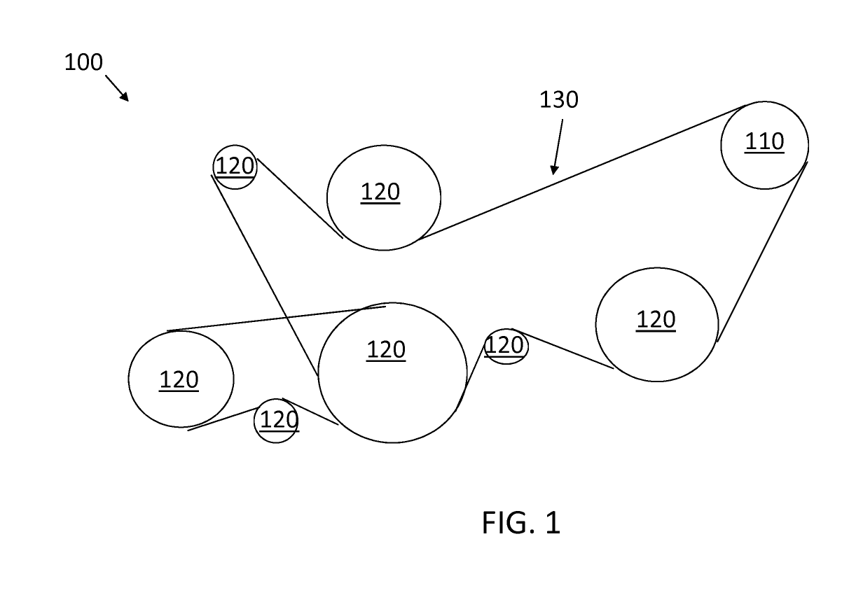

FIG. 1 is a cross-sectional view of aspects of a front end accessory drive (FEAD) system 100. An alternator 110 and other FEAD components 120 (e.g., power steering, air conditioning, tensioner, crank shaft, water pump, idler) are arranged to be driven, based on the crank shaft 120, by a serpentine belt 130. As FIG. 1 illustrates, the resonance in each FEAD component 120, 110 is transferred to the belt 130 that is used to drive the FEAD components 120, 110. These individual disturbances may amplify or cancel each other and, in some cases, may create a standing wave in the belt 130. Each of the FEAD components 120, 110 applies a torque to the FEAD system 100. As detailed below, the alternator 110 is controlled to affect the torque that it applies to the FEAD system 100 and thereby affect the instability of the FEAD system 100. Two specific embodiments are described. Each uses the same mechanism for control of the alternator 110 but operates based on a different trigger. It bears noting that control of the stability of the FEAD system 100 may be a continuous process (the stability may be monitored periodically or constantly on a continual basis), but the action required to prevent or mitigate instability operates on the order of milliseconds. This is because disturbing an oscillation (to prevent the development of a standing wave on the belt 130, for example) requires a very small interruption, as further discussed below.

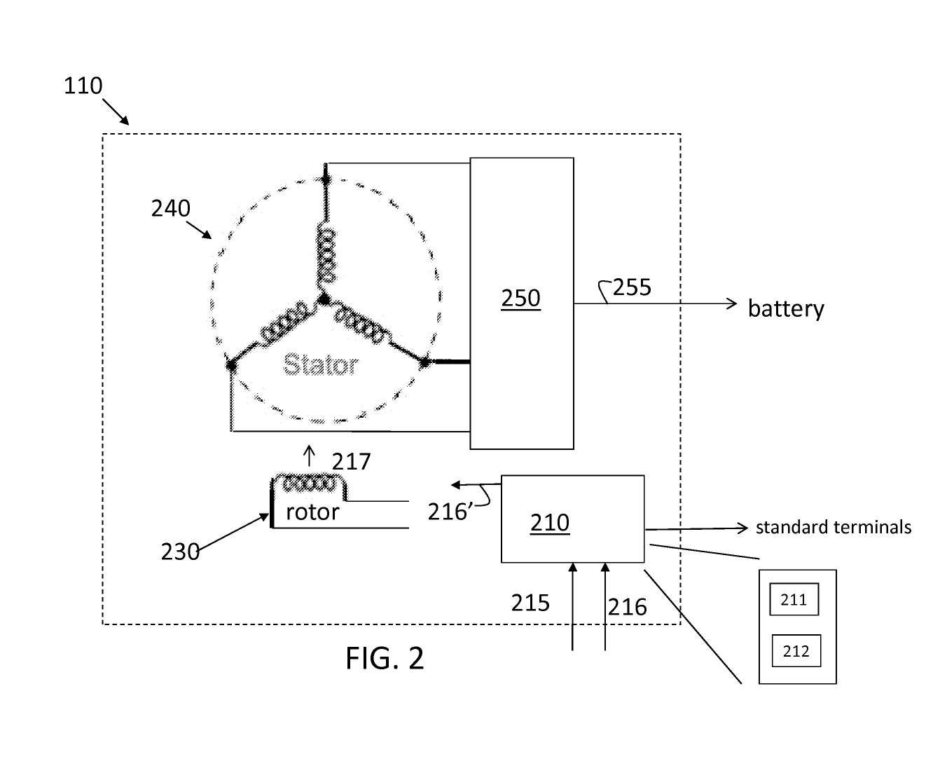

FIG. 2 is a simplified block diagram of an alternator 110 according to embodiments of the invention. The voltage regulator 210 controls the duty cycle of an input voltage 216 and outputs a pulse width modulated (PWM) field voltage 216′ to affect field current 217 at the rotor 230. The direct current (DC) field current 217 flowing through the wire coil of the rotor 230 produces a magnetic field around the core of the rotor 230. As the rotor 230 rotates within the stator 240, a number (corresponding with a phase count or number of coils of the stator 240) of output voltages are produced by the number of coils (e.g., three as shown in FIG. 2), respectively, which are converted to DC voltage by a rectifier 250. This output voltage 255 is used to recharge the battery. Thus, the voltage regulator 210 controls the field voltage 216 duty cycle to ensure that the proper field current 217 is output to result in the correct output voltage 255. The control of the duty cycle of the field voltage 216 by the voltage regulator 210, which affects the field current 217, which affects the output voltage 255, also affects the torque applied by the alternator 110 on the FEAD system 100.

The embodiments discussed herein relate to controlling the duty cycle of the field voltage 216 in order to affect the torque applied to the FEAD system 100 and, consequently, affect the stability of the FEAD system 100. The voltage regulator 210 overrides or momentarily interrupts the control of field voltage 216 duty cycle for the purpose of generating the correct output voltage 255 (for a period on the order of milliseconds) in order to break an oscillation that may ultimately damage the FEAD system 100. The embodiments discussed below are with reference to analysis performed by the voltage regulator 210, which may be microprocessor-based or a digital signal processor (DSP), for example. In alternate or additional embodiments, some or all of the functionality with regard to determining the action to be taken with the duty cycle of the field voltage 216 may be performed by another controller (other than the voltage regulator 210) that also includes one or more processors 211 and one or more memory devices 212.

The voltage regulator 210 (or other controller) determines a change in duty cycle of the field voltage 216 according to one of two embodiments described herein. According to one embodiment, the inputs 215 include information that is readily available to the voltage regulator 210 such as, for example, the pulse width modulation, the rotor 230 speed, rotor shaft 235 acceleration, and displacement. The output voltage 255 is not a constant value, but, instead, has an expected resonance in accordance with the field current 217. Based on the inputs 125, this expected resonance may be determined by computation, experimentation, or a combination of the two. The expected resonance is compared with the actual resonance on the output voltage 255. Based on the comparison (the difference between expected and actual resonance), a duty cycle change for the field voltage 216 is determined to interrupt or momentarily cancel the actual resonance to break the oscillation. The duty cycle of field voltage 216 that is needed to cancel the actual resonance may be computed, determined based on experimentation, or a combination of both. As noted previously, the action (duty cycle change) taken to affect oscillation is done on the order of milliseconds. As such, a perceptible change in output voltage 255 (from the perspective of the battery) is not generated because of the active vibration damping through duty cycle control.

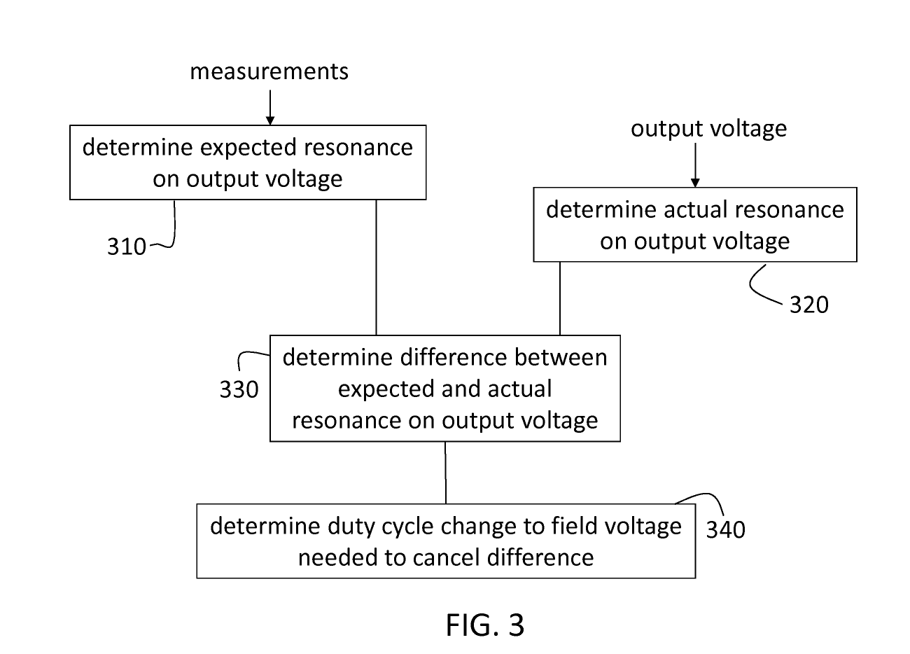

FIG. 3 is a process flow of a method of performing active vibration damping of the FEAD system 100 according to an embodiment of the invention. According to the embodiment discussed above and here, with reference to FIG. 3, the FEAD system 100 vibration is mitigated by controlling alternator 110 vibration. At block 310, determining expected resonance on the output voltage 255 of the alternator 110 includes obtaining measurements of rotor 230 speed, rotor shaft 235 acceleration, and displacement (and other values based on the specific technique used). The determining may be done by computation, experimentation, or a combination. At block 320, determining actual resonance on the output voltage 255 of the alternator 110 includes examining the output voltage 255 directly. At block 330, determining a difference between the expected and actual resonance on the output voltage 255 indicates the resonance that must be controlled (canceled) momentarily. At block 340, determining the duty cycle change for the field voltage 216 that is needed to cancel the difference between the expected and actual resonance on the output voltage 255 may be done computationally, experimentally, or by a combination. The counteracting forcing function (resonance resulting from the duty cycle change) would have an opposite phase from the resonance (the additional resonance indicated by the difference) to be counteracted or canceled. The duty cycle change is made on the order of milliseconds such that the output voltage 255 perceptible to the battery (supplied by the alternator 110) is not changed.

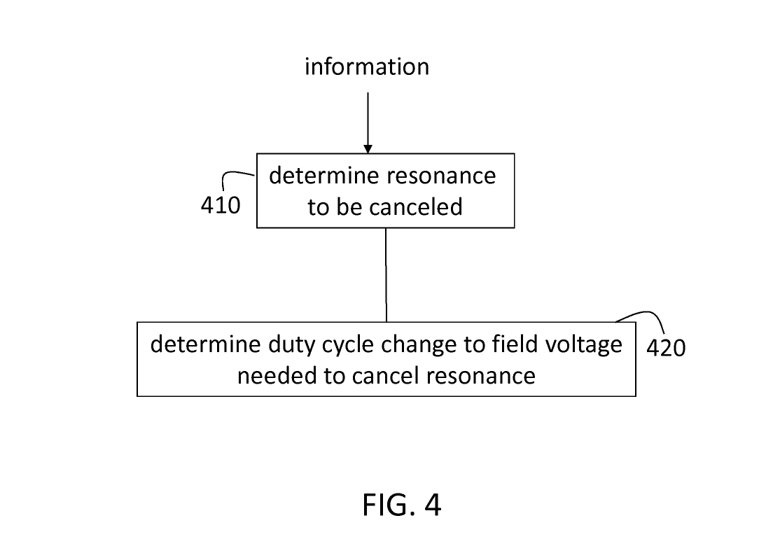

As indicated above, another embodiment of active vibration damping is discussed. According to another embodiment, the inputs 215 include information about resonance generated by the FEAD components 120 other than the alternator 110 itself This embodiment is detailed below with reference to FIG. 4. According to this embodiment, the voltage regulator 210 (or other controller) controls the duty cycle of the field voltage 216 to undercut the resonance (torque effects) of other FEAD components 120 to the overall FEAD system 100. As noted above, this embodiment may be combined with the embodiment discussed with reference to FIG. 3. That is, the alternator 110 may be used to cancel both the resonance introduced by itself and to counteract the resonance introduced to the FEAD system 100 by other FEAD components 120. The momentary change in duty cycle of the field voltage 216 implemented by the voltage regulator 210 has the effect of damping overall vibration of the FEAD system 100 by counteracting the vibration contribution of other FEAD components 120 in addition to or instead of the alternator 110 (as opposed to reducing damping of overall vibration of the FEAD system 100 by reducing the vibration contribution produced by the alternator 110 itself, as in the previous embodiment). Again, according to both embodiments, the change in duty cycle of the field voltage 216 (change from the duty cycle used to generate the required output voltage 255) that is used to mitigate oscillations is implemented for a period of time on the order of milliseconds. As a result, the primary function of the alternator 110 to recharge the battery with the correct output voltage 255 is not affected.

FIG. 4 is a process flow of a method of performing active vibration damping of the FEAD system 100 according to another embodiment of the invention. According to the embodiment discussed above and here, with reference to FIG. 3, the FEAD system 100 vibration is mitigated by controlling alternator 110 vibration. At block 310, determining the resonance to be canceled is based on information about disturbances introduced to the FEAD system 100 by other FEAD components 120. This information may include amplitude, phase, and frequency of the alternating current (AC) voltage produced by the stator 240 of the alternator 110, for example. Determining the duty cycle change to field voltage 216 needed to cancel the resonance introduced to the FEAD system 100 by other FEAD components 120, at block 420, may be done by computation, experimentation, or a combination of the two. What must be determined specifically is the duty cycle that will result in the field current 217 that will result in the output voltage 255 with a resonance that is out of phase with the resonance to be counteracted or canceled momentarily.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. A method of performing active vibration damping in a front end accessory drive (FEAD) system of an automobile using an alternator of the FEAD system, the method comprising:
determining a resonance to be counteracted;
determining a counteracting forcing function to counteract the resonance;
determining a duty cycle change to apply to a field voltage to obtain an output voltage with the counteracting forcing function, wherein the field voltage results in a field current supplied to a rotor that causes a stator to generate the output voltage; and
implementing the duty cycle change for a period of time.

2. The method according to claim 1, wherein the implementing for the period of time is on the order of milliseconds.

3. The method according to claim 1, further comprising repeating each of the determining the resonance, the determining the counteracting forcing function, the determining the duty cycle change, and the implementing periodically.

4. The method according to claim 1, further comprising obtaining information to perform the determining the resonance.

5. The method according to claim 4, wherein the obtaining the information includes obtaining rotor speed, rotor shaft acceleration, displacement, and a measure of actual resonance on the output voltage.

6. The method according to claim 5, further comprising determining an expected resonance based on the information.

7. The method according to claim 6, wherein the determining the resonance to be counteracted is based on a difference between the expected resonance and the actual resonance on the output voltage.

8. The method according to claim 4, wherein the obtaining the information includes obtaining measurements to determine other resonances introduced to the FEAD system by other components, other than the alternator.

9. The method according to claim 8, wherein the determining the resonance to be counteracted is based on a combination of the other resonances.

10. The method according to claim 1, wherein the determining the duty cycle change is based on calculation, experimentation, or a combination of the calculation and the experimentation.

11. An alternator of a front end accessory drive (FEAD) system of an automobile configured to perform active vibration damping, the alternator comprising:
a voltage regulator configured to control a field current at a rotor, the voltage regulator controlling the field current by controlling a duty cycle of a pulse width modulated field voltage;
the rotor configured to generate a magnetic field based on the field current;
a stator surrounding the rotor, the stator generating an output voltage of the alternator based on the magnetic field; and
a processor configured to determine a change in the duty cycle of the field voltage for a period of time to generate the output voltage with a counteracting forcing function to perform the active vibration damping.

12. The alternator according to claim 11, wherein the processor is part of the voltage regulator.

13. The alternator according to claim 11, wherein the period of time is on the order of milliseconds.

14. The alternator according to claim 11, wherein the processor determines the change in the duty cycle periodically.

15. The alternator according to claim 11, wherein the processor determines the change in the duty cycle of the field voltage based on obtaining information including rotor speed, rotor shaft acceleration, displacement, and a measure of actual resonance on the output voltage.

16. The alternator according to claim 15, wherein the processor determines an expected resonance on the output voltage based on the information.

17. The alternator according to claim 16, wherein the processor determines a difference between the expected resonance and the actual resonance on the output voltage as a resonance to be counteracted.

18. The alternator according to claim 17, wherein the processor determines the change in the duty cycle of the field voltage to generate a counteracting forcing function that counteracts the resonance to be counteracted.

19. The alternator according to claim 11, wherein the processor determines the change in duty cycle of the field voltage based on obtaining information indicating other resonances introduced to the FEAD system by other components, other than the alternator.

20. The alternator according to claim 19, wherein the processor determines the change in the duty cycle of the field voltage to generate a counteracting forcing function that counteracts the other resonances.
